(19) United States
(12) Patent Application Publication
(10) Pub. No.: US 2017/0061580 A1
(43) Pub. Date: Mar. 2, 2017

(54) RESCALING AND/OR RECONSTRUCTING IMAGE DATA WITH DIRECTIONAL INTERPOLATION

(71) Applicant: QUALCOMM Incorporated, San Diego, CA (US)

(72) Inventors: Daniel Stan, Richmond Hill (CA); Min Li, San Diego, CA (US); Vladimir Lachine, Toronto (CA)

(21) Appl. No.: 15/088,764

(22) Filed: Apr. 1, 2016

Related U.S. Application Data
(60) Provisional application No. 62/211,586, filed on Aug. 28, 2015.

(51) Int. Cl. G06T 3/40; G06K 9/56; G06K 9/46

(52) U.S. Cl. CPC G06T 3/4007; G06K 9/4647; G06T 3/4015; G06K 9/56

(57) ABSTRACT

Rescaling or reconstructing of a digital image may be accomplished by directional interpolation, so that interpolation is done in the direction perpendicular to the gradient—the direction in which the change in pixel values is the smallest. Each pixel is generated by interpolation in the output image as a weighted average of nearby pixels, in which the weighting is done in the direction of the gradient. The interpolation is accomplished with an adaptive filter that has an elliptical frequency response determined by the direction of the gradient. The filter uses filter coefficients that are a function of the direction. Rather than storing coefficients for each of several directions, three filter coefficients are stored—one set for non-directional filter, one for one direction such as 45 degrees, and another for another direction such as 135 degrees. A blending of the filter coefficients is used.

This application claims the benefit of U.S. Provisional Application No. 62/211,586, filed Aug. 28, 2015, the entire content of which is incorporated by reference herein.

### TECHNICAL FIELD

This disclosure relates to video and graphics processing, and in particular the resampling (e.g., upscaling and/or downscaling) of image and/or video data with interpolation techniques.

### BACKGROUND

In some examples, a digital image may include a two-dimensional array of digital data with each entry representing a pixel of the digitized image. Each pixel may have one or more components to represent a color, e.g. red, green, and blue. One image processing operation is expanding an image by an arbitrary factor and thereby creating an enlarged image. De-interlacing is an example of such an operation where a video field is enlarged in vertical direction, for example, with a 1:2 scale factor. Creating an enlarged or reduced image from an original image, or reconstructing an image, can be accomplished by interpolation between pixels of the original digital data array to achieve a high quality output image.

### SUMMARY

Rescaling or reconstructing of a digital image (e.g., a still image or a frame of video data) may be accomplished by directional interpolation. Rescaling includes, inter alia, downscaling and upscaling, and reconstructing includes, inter alia, demosaicing and other forms of reconstruction of the image. “Directional interpolation” means that rather than performing bilinear or bicubic interpolation to generate each pixel of the scaled image, for example, the directional interpolation is performed in the direction perpendicular to that gradient—the direction in which the change in pixel values is the smallest. Bilinear or bicubic interpolation refers to linear or cubic interpolation in two directions—specifically, the horizontal direction and the vertical direction. Pixels generated by interpolation in the output image may be determined as a weighted average of nearby pixels, in which the weighting is done in the direction of the (pixel value) gradient. In one example, the interpolation may be accomplished with an adaptive filter that has an elliptical frequency response, where the frequency response is determined by the direction of the gradient. The filter uses filter coefficients that are a function of the direction. Rather than storing coefficient sets for each of several quantized directions, three sets of filter coefficients are stored—one set of filter coefficients for a non-directional filter, one set of filter coefficients for one direction such as 45 degrees, and another set of filter coefficients for another direction such as 135 degrees. A blending of the filter coefficients is used for any given direction when performing the filtering. By storing three sets of filter coefficients rather than a large number of filter coefficient sets for each of several quantized directions, significant memory savings may be achieved.

In some examples, a method for image processing comprises: receiving input digital image data including a plurality of pixels; providing output digital image data such that the output digital image data has a plurality of coordinates, wherein providing the output digital image data includes, for each coordinate in the output digital image data: determining a block of corresponding neighboring pixels in the input digital image data; determining a direction of a gradient of pixel values of the pixels in the block of corresponding neighboring pixels; and determining a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

In some examples, a device for image processing comprises: a memory that is configured to store three sets of filter coefficients; and one or more processors that are configured to: receive input digital image data including a plurality of pixels; provide output digital image data such that the output digital image data has a plurality of coordinates, wherein providing the output digital image data includes, for each coordinate in the output digital image data: determine a block of corresponding neighboring pixels in the input digital image data; determine a direction of a gradient of pixel values of the pixels in the block of corresponding neighboring pixels; and determine a pixel value for the coordinate in the output digital image data based on the block of corresponding neighboring pixels, the determined direction of the gradient, and the three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

In some examples, a device for image processing comprises: means for receiving input digital image data including a plurality of pixels; means for providing output digital image data such that the output digital image data has a plurality of coordinates, wherein the means for providing the output digital image data includes, for each coordinate in the output digital image data: means for determining a block of corresponding neighboring pixels in the input digital image data; means for determining a direction of a gradient of pixel values of the pixels in the block of corresponding neighboring pixels; and means for determining a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determination direction of the gradient, and wherein the three stored sets of filter coefficients includes a set of non-directional filter coefficients, a set of filter coefficients for a first pre-defined direction of interpolation, and a set of filter coefficients for a second pre-defined direction of interpolation that is different than the first pre-defined direction of interpolation.

In some examples, a non-transitory computer-readable medium has stored thereon instructions that, when executed, cause at least one processor to: receive input digital image data including a plurality of pixels; provide output digital image data such that the output digital image data has a plurality of coordinates, wherein providing the output digital image data includes, for each coordinate in the output digital image data: determine a block of corresponding neighboring pixels in the input digital image data; determine a direction of a gradient of pixel values of the pixels in the block of corresponding neighboring pixels; and determine a pixel value for the coordinate in the output digital image data based on the block of corresponding neighboring pixels, the determined direction of the gradient, and the three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram showing an example computing device configured to use the techniques of this disclosure.

FIG. 2 is a block diagram showing an example of the display engine/processor of FIG. 1 in a more general context, in accordance with techniques of the disclosure.

FIG. 3 is a flow chart showing an example of a process that may be employed by the display engine/processor of FIG. 2.

FIGS. 4A-4D illustrate quantities related to the gradient.

FIG. 5 shows filtering profiles for filtering via sets of filter coefficients.

FIG. 6 shows a quality comparison for an image upscaled by a factor of 4.

### DETAILED DESCRIPTION

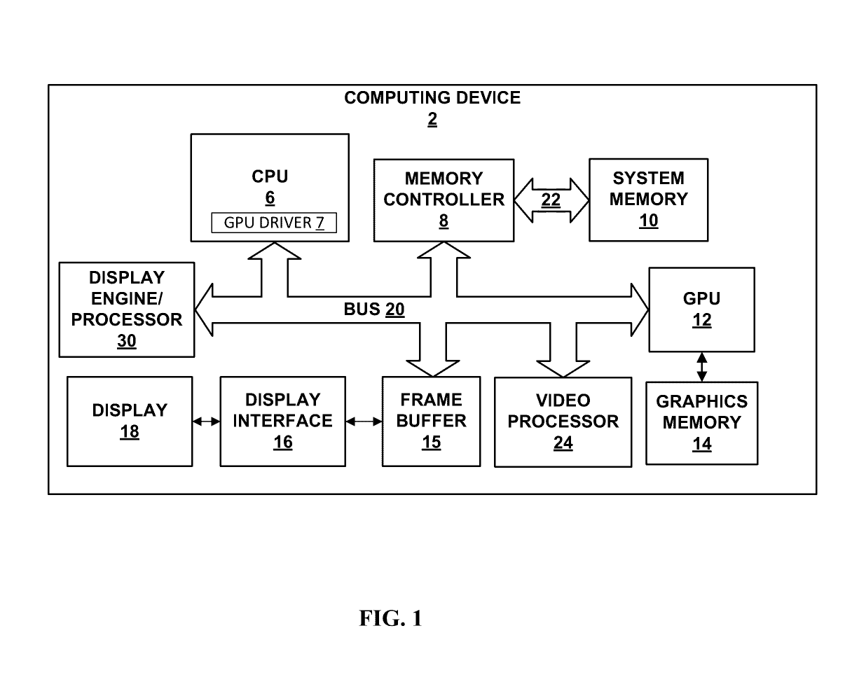

FIG. 1 is a block diagram showing an example computing device configured to use the techniques of this disclosure. As illustrated in the example of FIG. 1, computing device 2 may include a central processing unit (CPU) 6, a memory controller 8, a system memory 10, a graphics processing unit (GPU) 12, a graphics memory 14, a display interface 16, a display 18, video processor 24, a display engine/processor 30, and buses 20 and 22. Note that in some examples, graphics memory 14 may be “on-chip” with GPU 12. In some cases, all hardware elements shown in FIG. 1 may be on-chip, for example, in a system on a chip (SoC) design. CPU 6, memory controller 8, GPU 12, display engine/processor 30, and display interface 16 may communicate with each other using bus 20. Memory controller 8 and system memory 10 may also communicate with each other using bus 22.

Buses 20, 22 may be any of a variety of bus structures, such as a third generation bus (e.g., a HyperTransport bus or an InfiniBand bus), a second generation bus (e.g., an Advanced Graphics Port bus, a Peripheral Component Interconnect (PCI) Express bus, or an Advanced eXentisible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. Additionally, CPU 6 may execute a GPU driver 7 for controlling the operation of GPU 12. The user may provide input to computing device 2 via one or more input devices (not shown) such as a keyboard, a mouse, a microphone, a touch pad or another input device that is coupled to computing device 2 via a user input interface (not shown).

The software applications that execute on CPU 6 may include one or more graphics rendering instructions that instruct CPU 6 to cause the rendering of graphics data to display 18. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, or any other public or proprietary standard graphics API. In order to process the graphics rendering instructions, CPU 6 may issue one or more graphics rendering commands to GPU 12 (e.g., through GPU driver 7) to cause GPU 12 to perform some or all of the rendering of the graphics data. In some examples, the graphics data to be rendered may include a list of graphics primitives, e.g., points, lines, triangles, quadrilaterals, triangle strips, etc.

Memory controller 8 facilitates the transfer of data going into and out of system memory 10. For example, memory controller 8 may receive memory read and write commands, and service such commands with respect to memory system 10 in order to provide memory services for the components in computing device 2. Memory controller 8 is communicatively coupled to system memory 10 via memory bus 22. Although memory controller 8 is illustrated in FIG. 1 as being a processing module that is separate from both CPU 6 and system memory 10, in other examples, some or all of the functionality of memory controller 8 may be implemented on one or both of CPU 6 and system memory 10.

System memory 10 may store program modules and/or instructions that are accessible for execution by CPU 6 and/or data for use by the programs executing on CPU 6. For example, system memory 10 may store a window manager application that is used by CPU 6 to present a graphical user interface (GUI) on display 18. In addition, system memory 10 may store user applications and application surface data associated with the applications. System memory 10 may additionally store information for use by and/or generated by other components of computing device 2. For example, system memory 10 may act as a device memory for GPU 12 and may store data to be operated on by GPU 12 as well as data resulting from operations performed by GPU 12. For example, system memory 10 may store any combination of texture buffers, depth buffers, stencil buffers, vertex buffers, frame buffers, or the like. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data media or an optical storage media.

GPU 12 may be configured to perform graphics operations to render one or more graphics primitives to display 18. Thus, when one of the software applications executing on CPU 6 requires graphics processing, CPU 6 may provide graphics commands and graphics data to GPU 12 for rendering to display 18. The graphics data may include, e.g., drawing commands, state information, primitive information, texture information, etc. GPU 12 may, in some instances, be built with a highly-parallel structure that provides more efficient processing of complex graphic-related operations than CPU 6. For example, GPU 12 may include a plurality of processing elements that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 18 more quickly than drawing the scenes directly to display 18 using CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. GPU 12 may include one or more processors, such as one or more microprocessors, application specific integrated circuits (ASICs), field programmable gate arrays (FPGAs), digital signal processors (DSPs), or other equivalent integrated or discrete logic circuitry.

GPU 12 may be directly coupled to graphics memory 14. Thus, GPU 12 may read data from and write data to graphics memory 14 without using bus 20. In other words, GPU 12 may process data locally using a local storage, instead of off-chip memory. This allows GPU 12 to operate in a more efficient manner by eliminating the need of GPU 12 to read and write data via bus 20, which may experience heavy bus traffic. In some instances, however, GPU 12 may not include a separate memory, but instead utilize system memory 10 via bus 20. Graphics memory 14 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), Flash memory, a magnetic data media or an optical storage media.

CPU 6 and/or GPU 12 may store rendered image data in a frame buffer 15. Frame buffer 15 may be an independent memory or may be allocated within system memory 10. Display interface 16 may retrieve the data from frame buffer 15 and configure display 18 to display the image represented by the rendered image data. In some examples, display interface 16 may include a digital-to-analog converter (DAC) that is configured to convert the digital values retrieved from the frame buffer into an analog signal consumable by display 18. In other examples, display interface 16 may pass the digital values directly to display 18 for processing. Display 18 may include a monitor, a television, a projection device, a liquid crystal display (LCD), a plasma display panel, a light emitting diode (LED) array, such as an organic LED (OLED) display, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone. Alternatively, display 18 may be a stand-alone device coupled to computer device 2 via a wired or wireless communications link. For instance, display 18 may be a computer monitor or flat panel display connected to a personal computer via a cable or wireless link.

Video processor 24 may be configured to encode and/or decode video. Display engine/processor 30 may be configured to perform interpolation for image data when upscaling image data is performed. In some examples, the image data may include video data that includes one or more video frames, one or more still images, rendered graphics data, and/or the like. In some examples, the image data includes video data may include frames of video data produced by video processor 24 and/or frames of graphics data produced by GPU 12. In some examples, display engine/processor 30 is on chip with CPU 6 and GPU 12. In some examples, display engine/processor 30 includes one or more processors, such as, in some examples, one or more microprocessors, display processors, video processors, application specific integrated circuits (ASICs), field programmable gate arrays (FPGAs), digital signal processors (DSPs), or other equivalent integrated or discrete logic circuitry. In some examples, display engine/processor 30 receives data from system memory 10 and/or graphics memory 14 (via bus 20), including video data, and outputs data to system memory 10, video processor 24, and/or graphics memory 14 (via bus 20) or directly to frame buffer 15 (via bus 20) to be communicated to display interface 16. In some examples, display engine/processor 30 may perform 2D operations on either graphics images output by GPU 12 or video images produced by video processor 24 (including blending graphics and video together).

Display engine/processor 30 performs directional interpolation on pixels in the input data for the purposes of generating pixels in a rescaled and/or reconstructed version of the input data. In some examples, the directional interpolation is calculated using the average gradient square tensor from which the ratio Vy/G is used to provide the direction information, as explained in greater detail below. In some examples, the resulting directional information is used as a blending measure between a directional filter and a common circular/separate filter, as explained in greater detail below.

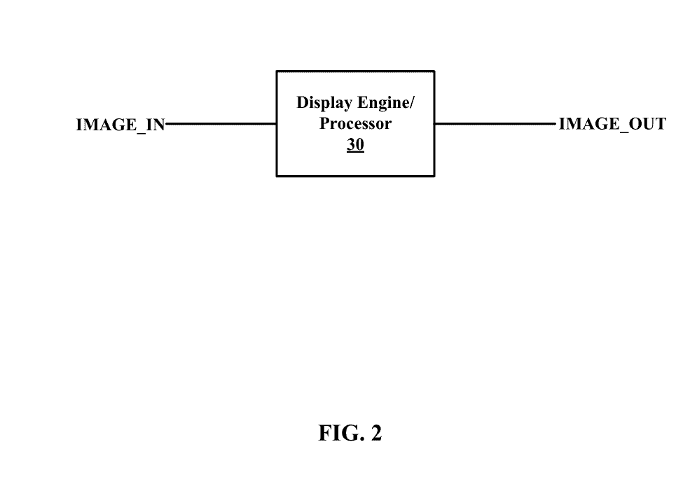

FIG. 2 is a block diagram of a context for display engine/processor 30 that is more general than the context illustrated in FIG. 1. FIG. 1 illustrates a particular context for display engine/processor 30 that includes other components such as a GPU, a CPU, and the like. In one example in accordance with FIG. 1, display engine/processor 30 may be part of a system-on-a-chip. However, as illustrated in FIG. 2, more generally, display engine/processor 30 may receive digital data IMAGE_IN, and output a re-scaled and/or reconstructed version IMAGE_OUT of the input digital image data IMAGE_IN, for which display engine/processor 30 performs directional interpolation for generating pixels for IMAGE_OUT. In some examples, the IMAGE_IN is input image data that may include video data that includes one or more video frames, one or more still images, rendered graphics data, and/or the like. In some examples, the IMAGE_OUT is output mage data that may include video data that includes one or more video frames, one or more still images, rendered graphics data, and/or the like. In some examples, IMAGE_IN is input digital image data that includes a plurality of pixels, and IMAGE_OUT is output digital image data such that the output digital image data is rescaled and/or reconstructed relative to the input digital image data, and the output digital image data has a plurality of coordinates. In some examples, display engine/processor 30 provides IMAGE_OUT by: determining a block of corresponding neighboring pixels in the input digital image data; determining a direction of a gradient of pixel values of the pixels in the block of corresponding neighboring pixels; and determining a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation, as explained in greater detail below.

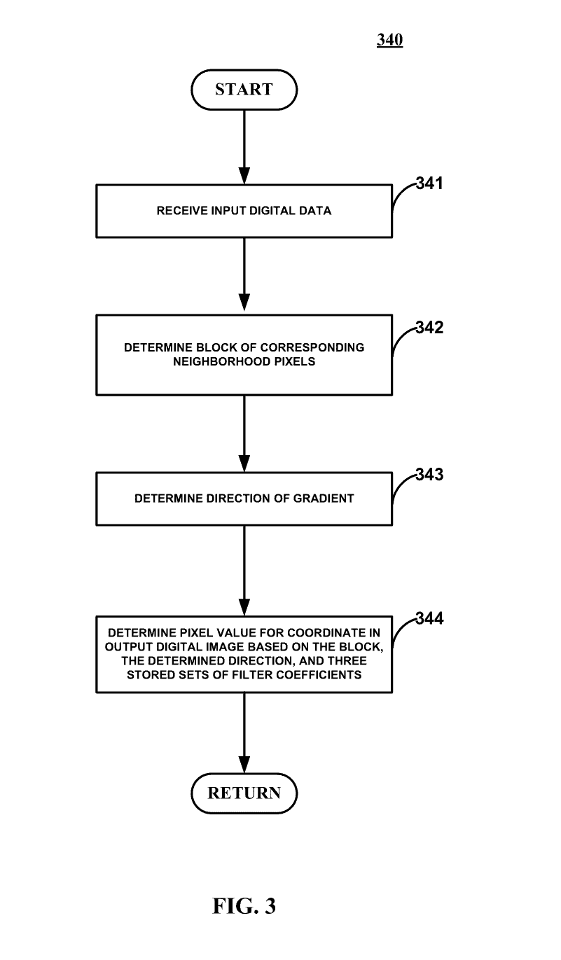

FIG. 3 shows an example of a flow chart of process 340, which may be employed by an example of display engine/processor 30 of FIG. 2.

After a start block, the process proceeds to block 341, where a display engine/processor (e.g., display engine/processor 30 of FIG. 2) receives input digital image data including a plurality of pixels. The process then proceeds to block 342, where the display engine/processor determines a block of corresponding neighboring pixels in the input digital image data. The process then moves to block 343, where the display engine/processor determines a direction of a gradient of pixel values of the pixels in the block of corresponding neighboring pixels. The process then advances to block 344, where the display engine/processor determines a pixel value for a coordinate in the output digital image data based on the block of corresponding neighboring pixels, the determined direction of the gradient, and three stored sets of filter coefficients. The determination of the pixel value is based on a blending of sets of filter coefficients in the three stored sets of filter coefficients based on the determined direction of the gradient. The three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation. The process then proceeds to a return block, where other processing is resumed.

Returning to FIG. 2, in some examples, display engine/processor 30 performs only the interpolation functions of the image rescaling or image filtering, and other aspects of the image rescaling or filtering may be performed by one or more device separate from display engine/processor 30, so that display engine/processor 30 does not necessarily itself directly receive image data IMAGE_IN or output image data IMAGE_OUT. In some examples, image data IMAGE_OUT is upscaled relative to digital image data IMAGE_IN. In other examples, image data IMAGE_OUT is downscaled relative to image data IMAGE_IN. In some examples, image data IMAGE_OUT is neither upscaled nor downscaled relative to image data IMAGE_IN, but is demosiaced (or interpolated, or reconstructed, or the like) relative to image data IMAGE_IN—for instance, in some of these examples, digital image data IMAGE_IN is a Bayer pattern image and image data IMAGE_OUT is demosaiced relative to digital image data IMAGE_IN. Actually, the term “rescaling” is not limited to upscaling and downscaling and is broad enough to cover, for example, demosaicing without downscaling or upscaling, but the term “rescaled and/or reconstructed” was used above to make it even more clear that that demosaicing and the like is included, not just upscaling and downscaling.

In some examples, display engine/processor 30 receives input digital image data. For instance, in some examples, the input digital data may be or include an input frame in a progressive video signal or a field in an interlaced video signal.

In some examples, after receiving input digital image data, display engine/processor 30 maps the coordinates of an output pixel onto the input image coordinate space. In various examples in accordance with the disclosure, the aforementioned transformation can range from a straightforward scaling to a complicated warping. Mapping output coordinates onto input coordinates, or so-called inverse transformation, has many advantages known to people skilled in the art, including covering the entire output pixel space and not leaving “holes” in the output image.

In some examples, the mapped position of an output pixel in the input image coordinate space is, in general, somewhere between the input pixels. In some examples the mapped coordinates are calculated via equations x′=Ox+xSx and y′=Oy+ySy, where x′,y′ are mapped coordinates of the output pixel in the input image coordinate space, Ox,Oy are the offsets relative to the leftmost input column and the topmost input line, and Sx,Sy are numbers of input columns and lines corresponding to each output column and line. In some examples, the input image is considered to consist of an array of color samples, spaced on a uniform grid.

In some examples, after display engine/processor 30 maps the coordinates of an output pixel onto the input image coordinate space, display engine/processor 30 determines, for each mapped coordinate, a block of input pixels around the coordinate. In some examples, a four-by-four block of contiguous input pixels is used for each coordinate. In this example, display engine/processor 30 determines a block of corresponding neighing pixels in the input digital image data IMAGE_IN by selecting the four-by-four block of neighboring pixels input the input image around the coordinates which are closest to making the coordinate the center of the block of neighboring pixels. In other examples, other suitable values may instead be employed.

In some examples, after display engine/processor 30 determines a block of pixels for a coordinate, display engine/processor 30 performs gradient calculations to determine the gradient values Vy and G, as explained in greater detail below, where Vy is a diagonal gradient and G is the local gradient.

For purposes of this document, the terms “direction” and “orientation” are used interchangeably, and are defined over the half angle range of 180 degrees. Accordingly, vectors with an angle difference of 180 degrees have the same orientation. The “direction” or “orientation” refers to the orientation of the pixel value gradient.

In one example, the gradient values are calculated using the gradient squared tensor (GST) calculation method. In one example, first, display engine/processor 30 computes the horizontal and vertical gradients (intensity variations from that pixel to the adjacent pixels) for pixels inside the block of image data. Then, display engine/processor 30 computes local GST values for each pixel in the block based on the calculated gradients. The gradient values Vy and G are then calculated.

A vectorial representation of the local orientation is introduced as a tensor, as follows:

$$T = \frac{1}{‖ v ‖} {vv}^{T} = \frac{1}{‖ v ‖} ( \begin{matrix}{x}^{2} & xy \\ xy & {y}^{2}\end{matrix} )$$

where ν=(x,y)^{T} is a vector along the dominant orientation and ∥ν∥=\sqrt{(x²+y²)} is the norm of the vector ν.

In some examples, for the case of a color image with red, green, and blue (RGB) components, display engine/processor 30 computes the GST by calculating gradients and corresponding tensors for each of the three color components and then averaging these tensors to obtain the GST as in the following:

$$GST = ( \begin{matrix}{\sum }_{i = 1}^{3} {( {g}_{x}^{i} )}^{2} & {\sum }_{i = 1}^{3} ( {g}_{x}^{i} {g}_{y}^{i} ) \\ {\sum }_{i = 1}^{3} ( {g}_{x}^{i} {g}_{y}^{i} ) & {\sum }_{i = 1}^{3} {( {g}_{y}^{i} )}^{2}\end{matrix} )$$

Alternatively, in other examples, display engine/processor 30 receives video data in YUV format, or converts the converts the input video data into YUV format, and calculates gradients over the luminance component only, as follows:

$$GST = ( \begin{matrix}{( {g}_{x}^{Y} )}^{2} & {g}_{x}^{Y} {g}_{y}^{Y} \\ {g}_{x}^{Y} {g}_{y}^{Y} & {( {g}_{y}^{Y} )}^{2}\end{matrix} )$$

In some examples, display engine/processor 30 calculates the GST as:

$$GST = ( \begin{matrix}{g}_{x} {g}_{x} & {g}_{x} {g}_{y} \\ {g}_{x} {g}_{y} & {g}_{y} {g}_{y}\end{matrix} )$$

$$where$$

$${g}_{x} ( x , y ) = \frac{\partial I ( x , y )}{\partial x}$$

$$and$$

$${g}_{y} ( x , y ) = \frac{\partial I ( x , y )}{\partial y}$$

are horizontal and vertical derivatives and I(x,y) represents the intensity of the image.

The average gradient square tensor (AGST) may be calculated as follows:

$$AGST = ( \begin{matrix}{G}_{xx} & {G}_{xy} \\ {G}_{xy} & {G}_{yy}\end{matrix} ) ( \begin{matrix}{\sum }_{j ∈ W} {{w}_{j} ( {g}_{x}^{j} )}^{2} & {\sum }_{j ∈ W} {w}_{j} {g}_{x}^{j} {g}_{y}^{j} \\ {\sum }_{j ∈ W} {w}_{j} {g}_{x}^{j} {g}_{y}^{j} & {\sum }_{j ∈ W} {{w}_{j} ( {g}_{x}^{j} )}^{2}\end{matrix} )$$

Because the equation for AGST is quadratic in form, the tensor elements may be averaged over the block without cancellation of opposite vectors.

As discussed above, a vectorial representation of the local orientation may be introduced as a tensor

$$T = \frac{1}{‖ v ‖} {vv}^{T} = \frac{1}{‖ v ‖} ( \begin{matrix}{x}^{2} & xy \\ xy & {y}^{2}\end{matrix} )$$

where ν=(x,y)^{T} is a vector along the dominant orientation and ∥ν∥=\sqrt{(x²+y²)} is the norm of the vector ν. Accordingly, display engine/processor 30 may calculate an average square difference values may be calculated for any direction, where, as discussed above, the direction may be defined by an angle from 0 to 180 degrees. To determine the gradient direction, G and Vy parameters are first calculated, for example, as follows. Sixteen pixels from the image may be used to calculate the following quantities:

g_{i,j}^{f}=p_{i+1,j+1}−p_{i,j}

g_{i,j}^{r}=p_{i,j+1}−p_{i,j}

g_{i,j}^{ff}=(g_{i,j}^{f})²

g_{i,j}^{rr}=(g_{i,j}^{r})²

where the p_{i,j} are the luminance components of the intermediate image generated by display engine/processor 30. The image may be subsampled horizontally and vertically. The local values g^{ff} and g^{rr} from the surrounding area are then averaged in an area W via the following equations:

$${G}_{i , j}^{ff} = {\sum }_{a ∈ W} {\sum }_{b ∈ W} {g}_{i + a , j + b}^{ff} . \\ {G}_{i , j}^{rr} = {\sum }_{a ∈ W} {\sum }_{b ∈ W} {g}_{i + a , j + b}^{rr} .$$

These averaged gradient values are used in the calculation of the local gradient, G.

$$G = \frac{1}{2} ( {G}^{ff} + {G}^{rr} )$$

and the gradient quantity Vy

$${V}_{y} = \frac{1}{2} ( {G}^{ff} + {G}^{rr} )$$

After calculating the gradient values Vy and G, display engine/processor 30 calculates, for each pixel, the direction and weight value.

The direction, in some examples, is estimated based on the AGST, using principal component analysis. The major eigenvector of the AGST corresponds to the direction in which the gradient is the largest. The ridge-valley direction, in which the gradient is the smallest, is perpendicular to this axis, and therefore, it is given by the shortest eigenvector. The corresponding major λ₁ and minor λ₂ eigenvalues, and direction angle α, which is the angle of the shortest eigenvector, are calculated from the following equations:

$${λ}_{1} = \frac{( {G}_{xx} + {G}_{yy} ) + \sqrt{{( {G}_{xx} - {G}_{yy} )}^{2} + 4 {G}_{xy}^{2}}}{2}$$

$${λ}_{2} = \frac{( {G}_{xx} + {G}_{yy} ) - \sqrt{{( {G}_{xx} - {G}_{yy} )}^{2} + 4 {G}_{xy}^{2}}}{2}$$

$$α = \frac{∠ ( {G}_{xx} - {G}_{yy} , 2 {G}_{xy} ) + π}{2}$$

$$where , \\ ∠ ( x , y ) = \{ \begin{matrix}0 , & ( x = 0 ) ( y = 0 ) \\ \frac{π}{2} , & ( x = 0 ) ( y > 0 ) \\ - \frac{π}{2} , & ( x = 0 ) ( y < 0 ) \\ {tan}^{- 1} ( \frac{y}{x} ) , & x > 0 \\ {tan}^{- 1} ( \frac{y}{x} ) + π , & x < 0\end{matrix}$$

Accordingly, in some examples, display engine/processor 30 determines the direction α of a gradient of pixel values of the pixels in the block of corresponding neighboring pixels based on the equations above.

The weight values, Vypn and Vynn, are calculated as follows:

$${V}_{ypn} = \{ \begin{matrix}\frac{{V}_{Y}}{G} & when {V}_{Y} \geq 0 \\ 0 & when {V}_{Y} < 0\end{matrix} , \\ {V}_{ynn} = \{ \begin{matrix}- \frac{{V}_{Y}}{G} & when {V}_{Y} < 0 \\ 0 & when {V}_{Y} \geq 0\end{matrix}$$

The weight values Vypn and Vynn are essentially equivalent to the gradient weight value V_{y}/G. When V_{y}/G is positive, Vypn=V_{y}/G and Vynn=0, and then V_{y}/G is negative, Vynn is equal to the absolute value of V_{y}/G and Vpn=0.

After calculating the edge values, display engine/processor 30 determines the value of each output pixel. In one example, this is accomplished as follows:

Out=Filter2D(In,[Vynn*Coeff(45)+Vypn*Coeff(135)+(1−Vypn−Vynn)*Coeff(C)])

Again, although the equation above uses Vynn and Vypn, by using Vynn and Vypn, the equation effectively uses the gradient weight value V_{y}/G as discussed above.

This equation for determining the value of each output pixel provides a two-dimensional (2D) adaptive filter. The adaptive filter makes use of filter coefficients, as explained in greater detail below.

In some examples, display engine/processor 30 uses the above equation for determining the value of each output pixel to determine, for each coordinate in the output digital image data IMAGE_OUT, a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determination direction of the gradient, and wherein the three stored sets of filter coefficients includes a set of filter coefficients for a central set of filter coefficients, a set of filter coefficients for a first pre-defined direction of interpolation (e.g., the direction of 45 degrees in one examples), and a set of filter coefficients for a second pre-defined direction of interpolation that is different than the first pre-defined direction of interpolation (e.g., the direction of 135 degrees in one example).

This equation for determining the value of each output pixel generates each pixel of the output image by performing a weighted average of each of the pixel around the output pixel, such as, for example, a four-by-four set of neighboring pixels with the output pixel in the center. The averaging is weighted in the direction. The filter coefficients are a function of the direction. Rather than saving coefficients for each of a number of quantized directions, instead the non-directional filter coefficients, the coefficients for a direction of 45 degrees, and the coefficients for a direction of 135 degrees are stored, and the output pixel is determined based on a blending function for each direction, where the blending is weighted based on the direction to achieve an appropriate blending (for example, the weighting of the 45 degree coefficient is very strong for a 46 degree direction).

In this equation for determining the value of each output pixel, Coeff(45) represents the set of filter coefficients for a 45 degree direction, Coeff(135) represents the set of filter coefficients for a 135 direction, and Coeff(C) represents a set of non-directional filter coefficients. The set of filter coefficients Coeff(C) refers to a filtering with no preferred directional of interpolation—that is, a circular low-pass filter in which each of the pixels in the four-by-four neighboring block are weighted equally in each direction. In some examples, values of Coeff(45), Coeff(135), and Coeff(C) are pre-stored in memory, such as system memory 10. Display engine/processor 30 calculates the output pixels in such a way that, rather needing to store 16 sets of filter coefficients, one for each of 16 different quantized directions, only three sets of filter coefficients are stored to calculate the output pixels for all directions.

Although an example with a central coefficient, a coefficient for 45 degrees, and a coefficient for 135 degrees are discussed above, other examples may use a central coefficient and two angles other than 45 degrees and 135 degrees, which are discussed by way of example only.

As previously discuss, values for Coeff(45), Coeff(135), and Coeff(C) may be pre-calculated and pre-stored in memory (e.g., system memory 10). In some examples, Coeff(45), Coeff(135), and Coeff(C) may be pre-calculated as follows.

The adaptive filter may use an elliptical filter for signal enlargement and/or enhancement. This kind of filter has an elliptical frequency response with two major cut-off frequencies: one along the edge and the other in the direction perpendicular to the edge. The 2D filter's coefficients are calculated using information about horizontal and vertical phases, elliptical filter's profile and directional matrix with four elements.

The 2D FIR filter has an elliptical frequency response with two parameterized cut-off frequencies: along the edge and in direction perpendicular of the edge. A footprint of the filter in frequency domain is an ellipse. Four values of the directional matrix may be used to adjust the radius (distance) to a pixel in accordance with orientation and cutoff frequencies of the filter response for each orientation. The matrix maps input pixels coordinates (x,y) into ellipse coordinates (x′,y′).

Generally speaking, the filtering footprint may include all pixels inside an ellipse. For example, elliptical footprint may be used for texture mapping together with a Gaussian filter.

A filter coefficient for display engine/processor 30 may be calculated obtaining a two-dimensional (2D) finite input response (FIR) filter by multiplying h_{d}(n₁,n₂) with a window w(n₁,n₂), where n₁ and n₂ are the x and y coordinates respectively.

h(n₁,n₂)=h_{d}(n₁,n₂)*w(n₁,n₂)

The filter equation may be given by:

$${h}_{d} ( {n}_{1} , {n}_{2} ) = \frac{{ω}_{c} ( θ )}{2 π \sqrt{{n}_{1}^{2} + {n}_{2}^{2}}} {J}_{1} ( {ω}_{c} ( θ ) \sqrt{{n}_{1}^{2} + {n}_{2}^{2}} )$$

where J₁( ) is the Bessel function of the first kind and the first order, θ is the direction, and ω_{c}(θ) is the cut-off frequency, which is a function of the direction in this example.

For the non-directional coefficients, the equation is the same, but ωₑ is a constant irrespective of the direction for the non-directional coefficients.

The window may be calculated as follows:

$$w ( {n}_{1} , {n}_{2} ) = \{ \begin{matrix}\frac{{J}_{0} ( β \sqrt{1 - ( {n}_{1}^{2} + {n}_{2}^{2} ) / {r}^{2}} )}{{J}_{0} ( β )} , & {n}_{1}^{2} + {n}_{2}^{2} \leq {r}^{2} \\ 0 , & otherwise\end{matrix}$$

where J₀( ) is the modified Bessel function of the first kind, order zero, β is a parameter and r is a radius of the window.

Display engine/processor 30, by executing the techniques described above, accomplishes directional interpolation. With directional interpolation, display engine/processor 30 performs the interpolation in the direction of the gradient—the direction in which the change in pixel values is the smallest. Display engine/processor 30 generates each pixel generated by interpolation in the output image as a weighted average of nearby pixels, in which the weighting is done in the direction of the gradient. Display engine/processor 30 accomplishes the interpolation with an adaptive filter that has an elliptical frequency response, where the frequency response is determined by the direction of the gradient. The filter uses filter coefficients that are a function of the direction. Rather than storing coefficient sets for each of many quantized directions, three filter coefficients are stored—one set of filter coefficients for a non-directional filter, one for one direction such as 45 degrees, and another for another direction such as 135 degrees. A blending of the filter coefficients is used for any given direction when performing the filtering. By storing three filter coefficients rather than a large number of filter coefficient sets for each separate quantized direction, significant memory savings may be achieved. The area may be significantly reduced, and a significant power saving may be achieved through significantly less memory accesses.

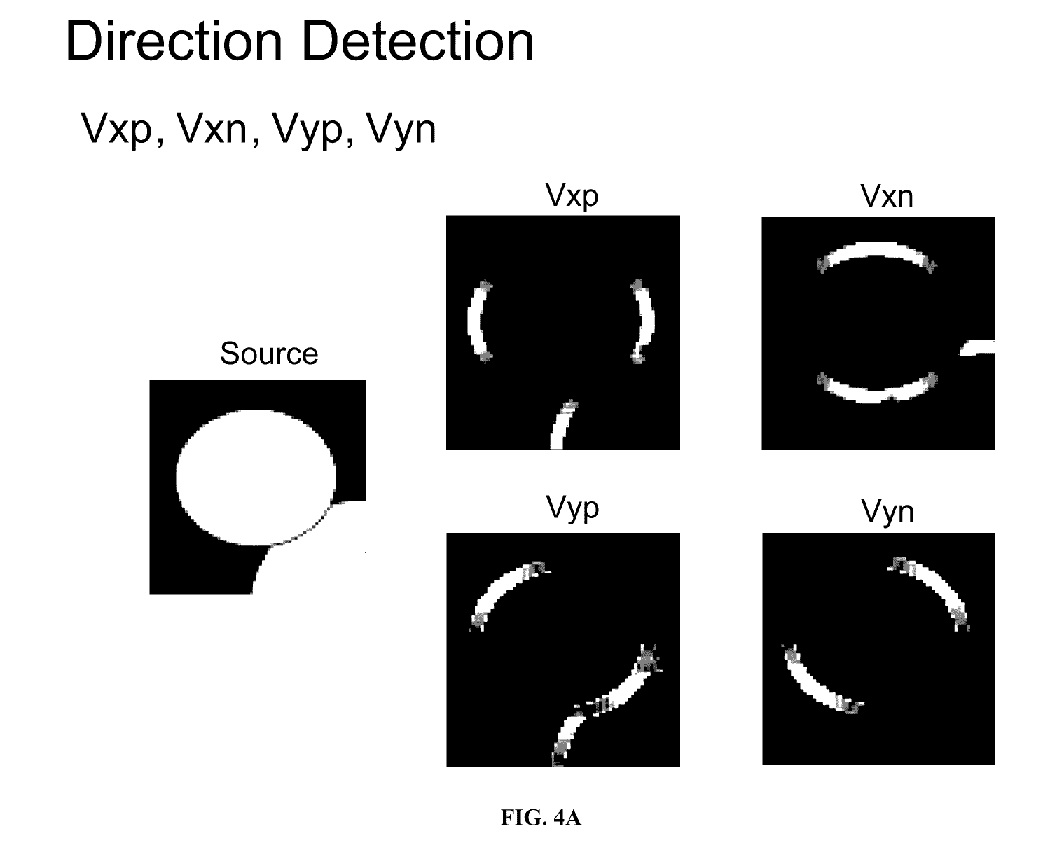

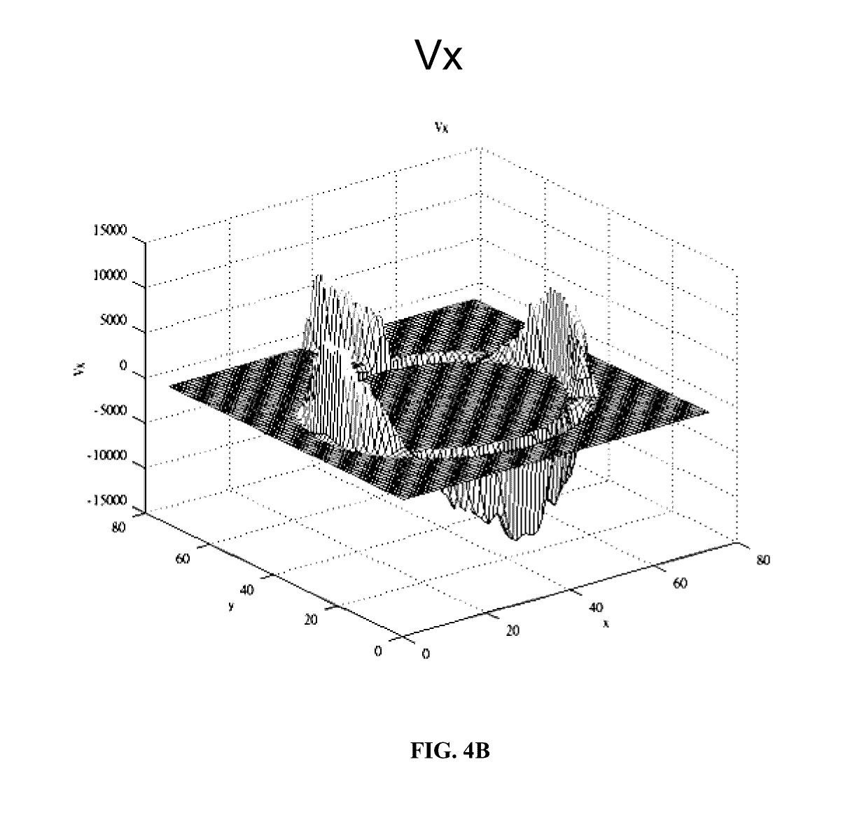

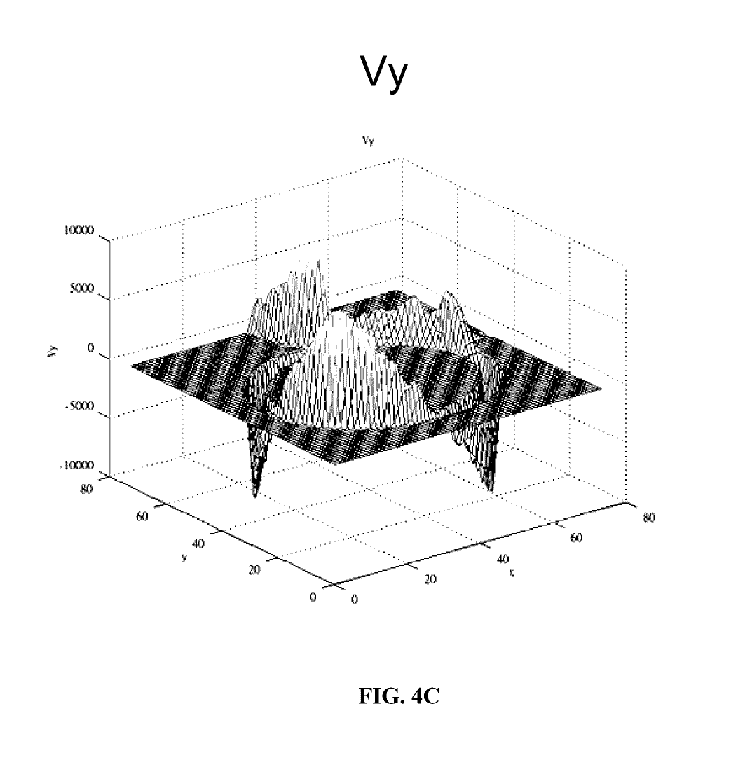

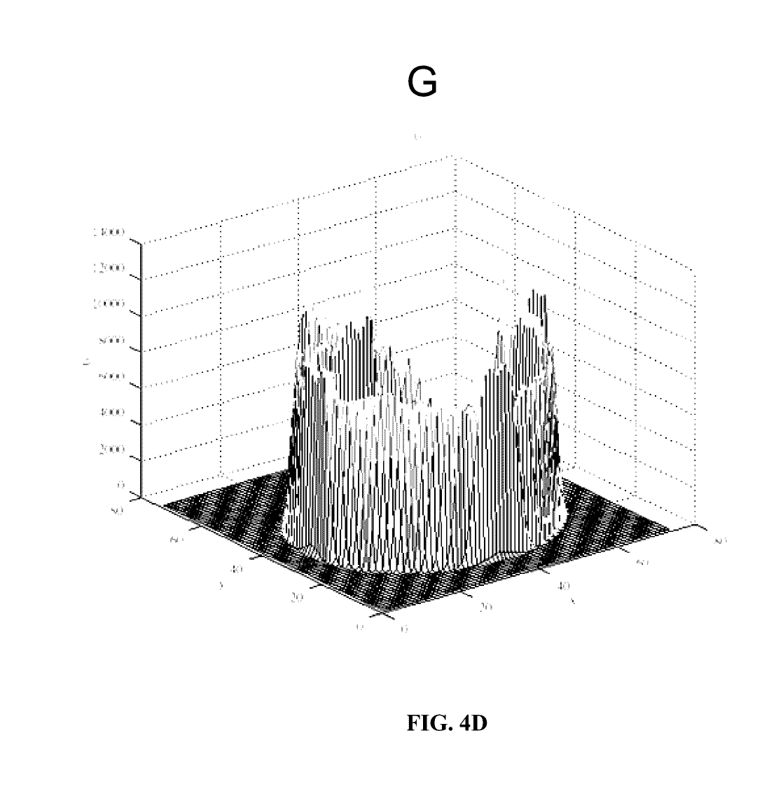

FIGS. 4A-4D illustrate quantities related to the gradient. In FIG. 4A, “Source” illustrates the source image. The top row illustrates Vxp and Vxn, which need not be used by display engine/processor 30. The image for Vxp shows the horizontal edges for the horizontal (intensity) gradient. On the transition from block to white, the horizontal transitions that have the highest value are the horizontal edges. The image for Vxn shows the horizontal edge for the vertical (intensity) gradient. The gradient is perpendicular to the actual edge being detected. For the edge of an object, the actual gradient is the strongest on the perpendicular to the actual direction. The image for Vyp shows the 45 degree gradient. The image for Vyn shows the 135 degree gradient.

FIGS. 4B-4D illustrate plots of the quantities Vx, Vy, and G, respectively.

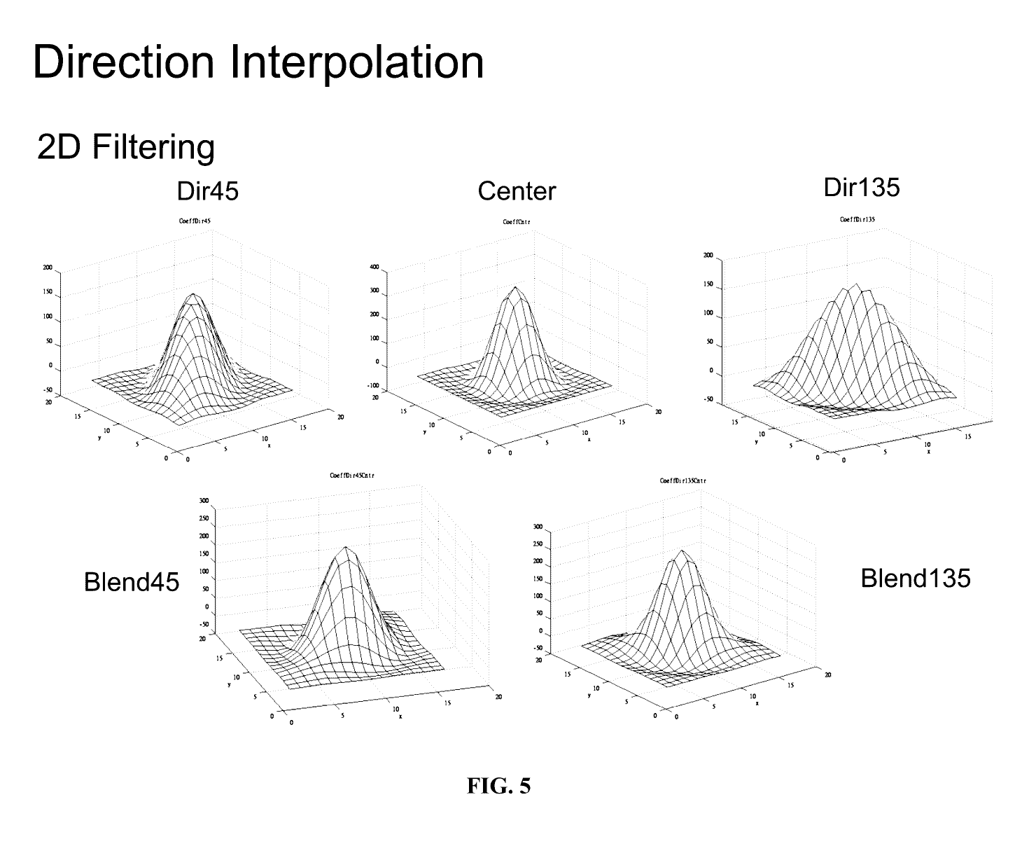

FIG. 5 shows filtering profiles for filtering via sets of filter coefficients. The top row shows the three stored sets of filtering coefficients. The top row shows the filter profiles for the three stored sets of filter coefficients: one of the 45 degree direction of interpolation (Dir45), one for the central set of filter coefficients (Center), and one for the 135 degree direction of interpolation (Dir135). As shown, the central set of filter coefficients has no preferred direction of interpolation. The bottom row shows filter profiles for poly-phase filter coefficients extracted from the filter coefficients profiles in the top row by blending.

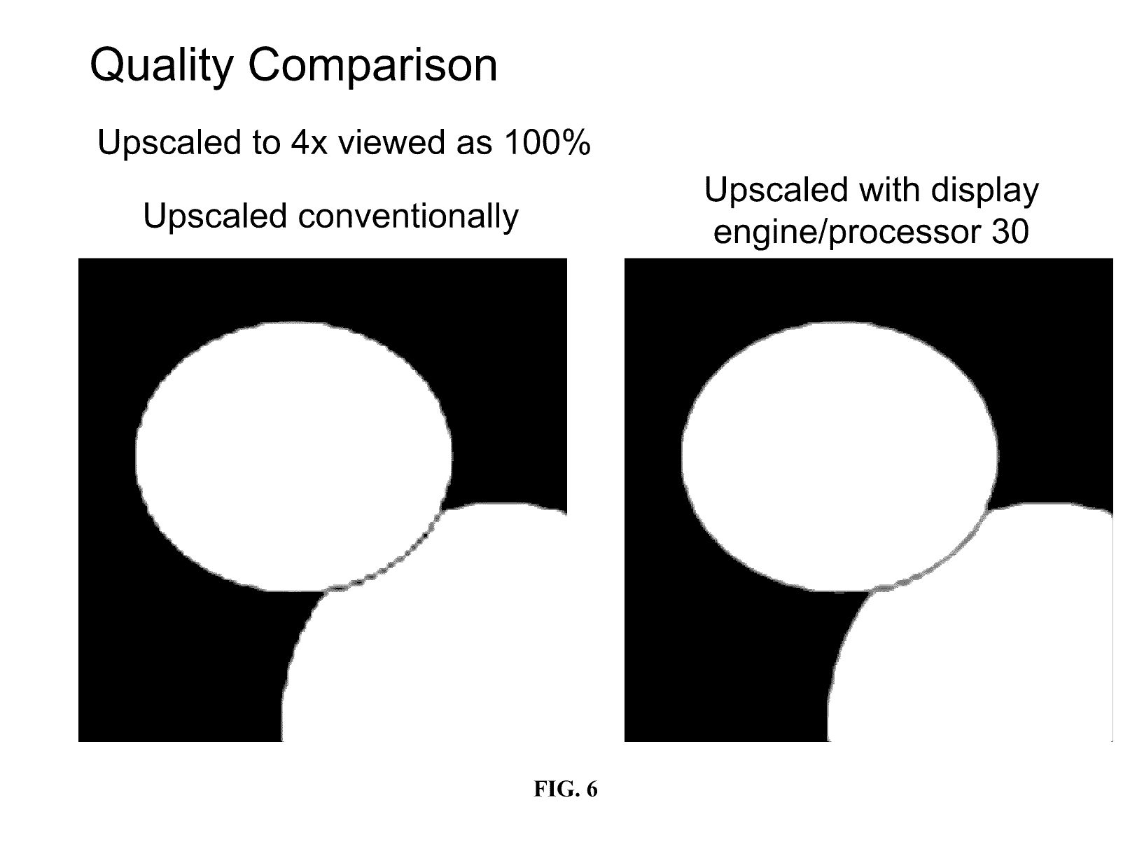

FIG. 6 shows a quality comparison for an image upscaled by a factor of 4 by display engine/processor 30 (right image) versus otherwise (left image).

In one or more examples, the functions described above may be implemented in hardware, software, firmware, or any combination thereof. If implemented in software, the functions may be stored as one or more instructions or code on an article of manufacture comprising a computer-readable medium. Computer-readable media may include computer data storage media. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage, or other magnetic storage devices, flash memory, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Through the specification and the claims, the term “tangible computer-readable storage medium” is specifically defined herein to exclude propagating signals per se, but the term “tangible processor-readable storage medium” does include random access memory (RAM), register memory, processor cache, and the like.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

Various examples have been described. These and other examples are within the scope of the following claims.

What is claimed is:

1. A method for image processing, comprising:
receiving input digital image data including a plurality of pixels;
providing output digital image data such that the output digital image data has a plurality of coordinates, wherein providing the output digital image data includes, for each coordinate in the output digital image data:
determining a block of corresponding neighboring pixels in the input digital image data;
determining a direction of a gradient of pixel values of the pixels in the block of corresponding neighboring pixels; and
determining a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

2. The method of claim 1, wherein determining the pixel value is accomplished by performing adaptive filtering with an elliptical frequency response, wherein the frequency response is determined based on the determined direction of the gradient, and wherein the adaptive filtering is based on the blending of the sets of filter coefficients in the three stored sets of filter coefficients based on the determined direction of the gradient.

3. The method of claim 1, wherein the determining the pixel value is accomplished by calculating a weighted average of each pixel in the block of corresponding neighboring pixels such that the weighting is done in the determined direction of the gradient, and such that calculating the weighted average is based on the blending of the sets of filter coefficients in the three stored sets of filter coefficients based on the determined direction of the gradient.

4. The method of claim 1, wherein providing the output digital image data is accomplished such that the output digital image data is at least one of rescaled relative to the input digital image data or reconstructed relative to the input digital image data.

5. The method of claim 1, wherein providing the output digital image data is accomplished such that the output digital image data is at least one of upscaled relative to the input digital image data, downscaled relative to the input digital image data, or demosaiced relative to the input digital image data.

6. The method of claim 1, wherein providing the output digital image data further includes:
determining a diagonal gradient V_{y} for the block of corresponding neighboring pixels, and determining a local gradient G for the block of neighboring pixels; and
determining a gradient weight value as V_{y}/G, wherein determining the pixel value for the coordinate in the output digital image data is based, at least in part, on the determined gradient weight value.

7. The method of claim 6, wherein providing the output digital image data further includes determining a weight value for each pixel in the in the block of corresponding neighboring pixels based, at least in part, on the diagonal gradient Vy and the local gradient G, and wherein determining the direction of the gradient of the pixel values of the pixels in the block of corresponding neighboring pixels includes determining a gradient for each pixel in the block of corresponding neighboring pixels based, at least in part, on the diagonal gradient Vy and the local gradient G.

8. The method of claim 6, wherein providing the output digital image data further includes:
calculating a horizontal intensity gradient for the block of corresponding neighboring pixels;
calculating a vertical intensity gradient for the block of corresponding neighboring pixels; and
calculating a local gradient square tensor value for each pixel in the block of corresponding neighboring pixels based, at least in part, on the horizontal intensity gradient and the vertical intensity gradient, wherein determining the diagonal gradient V_{y} is based, at least in part, on the local gradient square tensor value for each pixel, and wherein the gradient weight value G is based, at least in part, on the local gradient square tensor value for each pixel.

9. A device for image processing, comprising:
a memory that is configured to store three sets of filter coefficients; and
one or more processors that are configured to:
receive input digital image data including a plurality of pixels;
provide output digital image data such that the output digital image data has a plurality of coordinates, wherein providing the output digital image data includes, for each coordinate in the output digital image data:
determine a block of corresponding neighboring pixels in the input digital image data;
determine a direction of a gradient of pixel values of the pixels in the block of corresponding neighboring pixels; and
determine a pixel value for the coordinate in the output digital image data based on the block of corresponding neighboring pixels, the determined direction of the gradient, and the three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

10. The device of claim 9, wherein the one or more processors are further configured such that determining the pixel value is accomplished by performing adaptive filtering with an elliptical frequency response, wherein the frequency response is determined based on the determined direction of the gradient, and wherein the adaptive filtering is based on the blending of the sets of filter coefficients in the three stored sets of filter coefficients based on the determined direction of the gradient.

11. The device of claim 9, wherein the one or more processors further configured such that determining the pixel value is accomplished by calculating a weighted average of each pixel in the block of corresponding neighboring pixels such that the weighting is done in the determined direction of the gradient, and such that calculating the weighted average is based on the blending of the sets of filter coefficients in the three stored sets of filter coefficients based on the determined direction of the gradient.

12. The device of claim 9, wherein the one or more processors are further configured such that providing the output digital image data is accomplished such that the output digital image data is at least one of rescaled relative to the input digital image data or reconstructed relative to the input digital image data.

13. The device of claim 9, wherein the one or more processors are further configured such that providing the output digital image data is accomplished such that the output digital image data is at least one of upscaled relative to the input digital image data, downscaled relative to the input digital image data, or demosaiced relative to the input digital image data.

14. The device of claim 9, wherein the one or more processors are further configured such that providing the output digital image data further includes:
determining a diagonal gradient V_{y} for the block of corresponding neighboring pixels, and determining a local gradient G for the block of neighboring pixels; and
determining a gradient weight value as V_{y}/G, wherein determining the pixel value for the coordinate in the output digital image data is based, at least in part, on the determined gradient weight value.

15. The device of claim 14, wherein the one or more processors are further configured such that providing the output digital image data further includes determining a weight value for each pixel in the in the block of corresponding neighboring pixels based, at least in part, on the diagonal gradient Vy and the local gradient G, and wherein the one or more processors are further configured such that determining the direction of the gradient of the pixel values of the pixels in the block of corresponding neighboring pixels includes determining a gradient for each pixel in the block of corresponding neighboring pixels based, at least in part, on the diagonal gradient Vy and the local gradient G.

16. The device of claim 14, wherein the one or more processors are further configured such that providing the output digital image data further includes:
calculating a horizontal intensity gradient for the block of corresponding neighboring pixels;
calculating a vertical intensity gradient for the block of corresponding neighboring pixels; and
calculating a local gradient square tensor value for each pixel in the block of corresponding neighboring pixels based, at least in part, on the horizontal intensity gradient and the vertical intensity gradient, wherein the one or more processors are further configured such that determining the diagonal gradient V_{y} is based, at least in part, on the local gradient square tensor value for each pixel, and such that the gradient weight value G is based, at least in part, on the local gradient square tensor value for each pixel.

17. A device for image processing, comprising:
means for receiving input digital image data including a plurality of pixels;
means for providing output digital image data such that the output digital image data has a plurality of coordinates, wherein the means for providing the output digital image data includes, for each coordinate in the output digital image data:
means for determining a block of corresponding neighboring pixels in the input digital image data;
means for determining a direction of a gradient of pixel values of the pixels in the block of corresponding neighboring pixels; and
means for determining a pixel value for the coordinate in the output digital image data based on the block of corresponding neighboring pixels, the determined direction of the gradient, and three stored sets of filter coefficients, wherein the determination of the pixel value is based on a blending of sets of filter coefficients in the three stored sets of filter coefficients based on the determination direction of the gradient, and wherein the three stored sets of filter coefficients includes a set of non-directional filter coefficients, a set of filter coefficients for a first pre-defined direction of interpolation, and a set of filter coefficients for a second pre-defined direction of interpolation that is different than the first pre-defined direction of interpolation.

18. The device of claim 17, wherein the means for providing the output data further includes:
means for determining a diagonal gradient V_{y} for the block of corresponding neighboring pixels, and determining a local gradient G for the block of neighboring pixels; and
means for determining a gradient weight value as V_{y}/G, wherein determining the pixel value for the coordinate in the output digital image data is based, at least in part, on the determined gradient weight value.

19. A non-transitory computer-readable medium having stored thereon instructions that, when executed, cause at least one processor to:
receive input digital image data including a plurality of pixels;
provide output digital image data such that the output digital image data has a plurality of coordinates, wherein providing the output digital image data includes, for each coordinate in the output digital image data:
determine a block of corresponding neighboring pixels in the input digital image data;
determine a direction of a gradient of pixel values of the pixels in the block of corresponding neighboring pixels; and
determine a pixel value for the coordinate in the output digital image data based on the block of corresponding neighboring pixels, the determined direction of the gradient, and the three stored sets of filter coefficients, wherein the determination of the pixel value is based on a blending of sets of filter coefficients in the three stored sets of filter coefficients based on the determined direction of the gradient, and wherein the three stored sets of filter coefficients include a set of non-directional filter coefficients, a set of filter coefficients for a first pre-defined direction of interpolation, and a set of filter coefficients for a second pre-defined direction of interpolation that is different than the first pre-defined direction of interpolation.

20. The non-transitory computer-readable medium of claim 19, wherein the instructions, when executed, further cause the at least one processor to:
determine a diagonal gradient V_{y} for the block of corresponding neighboring pixels, and determining a local gradient G for the block of neighboring pixels; and
determine a gradient weight value as V_{y}/G, wherein determining the pixel value for the coordinate in the output digital image data is based, at least in part, on the determined gradient weight value.
